(19) United States
(12) Patent Application Publication
(10) Pub. No.: US 2008/0168663 A1
(43) Pub. Date: Jul. 17, 2008

(54) Gardening shears

(76) Inventors: His-Shan Yang, Taipei (TW); James Yang, Taipei (TW)

Correspondence Address: PRO-TECHTOR INTERNATIONAL SERVICES, 20775 NORADA CT., SARATOGA, CA, 95070, US

(21) Appl. No.: 12/008,368

(22) Filed: Jan. 9, 2008

(30) Foreign Application Priority Data
Jan. 15, 2007 (TW) 096101465

(51) Int. Cl. B26B 13/22

(52) U.S. Cl. 30/254; 30/123.3

(57) ABSTRACT

A gardening shears includes a shears body, an actuating mechanism supported on the shears body, a nozzle assembly to be driven by the actuating mechanism, a container, a flexible tube connected between the nozzle assembly and the container for guiding a chemical fluid out of the container to the nozzle assembly for spraying onto the cutter blades of the shears body or the cut cross section of a stalk or twig as the actuating mechanism is forced to drive the nozzle during a cutting operation of shears body.

### BACKGROUND OF THE INVENTION

1. Field of the Invention

The present invention relates to a gardening implement and more particularly, to a gardening shears, which sprays a chemical fluid onto the cutter blades of the shears body or the cut section of the stalk or twig during operation, so that cutting and sterilization are done at a time.

2. Description of the Related Art

When thinning plants or harvesting vegetables, fruits or flowers, a gardening shears may be used. A gardening shears for thinning plants is called as thinning shears. A gardening shears for harvesting flowers, vegetables and fruits is called as harvesting shears. Gardening shears for different purposes have different shapes. However, regular gardening shears commonly comprises two cutter blades pivoted together for a scissor action.

To avoid spreading of plant pests when cutting a flower stalk or flowering twig and to protect the cut cross section of the plant against infection, the cut cross section of the stalk or twig must be sterilized. If the cut cross section of the plant is not sterilized immediately after cutting, the consequences will be serious, causing the plants to droop or to die.

Conventionally, the worker inserts the gardening shears into a chemical container that is fastened the worker's waist (or hung on the workers back) after each cut, thereby sterilizing the cutter blades of the gardening shears. Thus, the worker must repeat this gardening shears sterilizing action again and again when thinning or pruning plants. This gardening method is quite common, however it lacks efficiency, and may cause another problem, i.e., the worker may forget to insert the shears into the chemical container for sterilization. If the worker forgets to sterilize the shears when gardening, the consequences will be serious.

### SUMMARY OF THE INVENTION

The present invention has been accomplished under the circumstances in view.

It is the main object of the present invention to provide a gardening shears, which sprays a chemical fluid onto the cutter blades of the shears body or the cut cross section of the stalk or twig during operation so that cutting and sterilization are done at one time, increasing working efficiency and preventing serious consequences due to non-sterilization of the gardening shears.

To achieve this and other objects of the present invention, the gardening shears comprises a shears body, an actuating mechanism supported on the shears body, a nozzle assembly to be driven by the actuating mechanism, a container, a flexible tube connected between the nozzle assembly and the container. When operating the shears body to cut a stalk or twig, the actuating mechanism is forced to drive the nozzle assembly, causing a chemical fluid to be forced out of the container and sprayed onto the cutter blades of the shears body or the cut cross section of the stalk or twig.

### BRIEF DESCRIPTION OF THE DRAWINGS

FIG. 1 is a plain view of a harvesting shears according to the present invention.

FIG. 2 is a sectional view taken along line 2-2 of FIG. 1.

FIG. 3 is an oblique elevation of the harvesting shears shown in FIG. 1.

FIG. 4 is an exploded view of the harvesting shears shown in FIG. 3.

FIG. 5 is similar to FIG. 1 but showing the cutter blades closed.

FIG. 6 is a sectional view taken along line 6-6 of FIG. 5.

FIG. 7 shows an alternate form of the harvesting shears according to the present invention.

FIG. 8 is a perspective view of a thinning shears according to the present invention.

### DETAILED DESCRIPTION OF THE PREFERRED EMBODIMENT

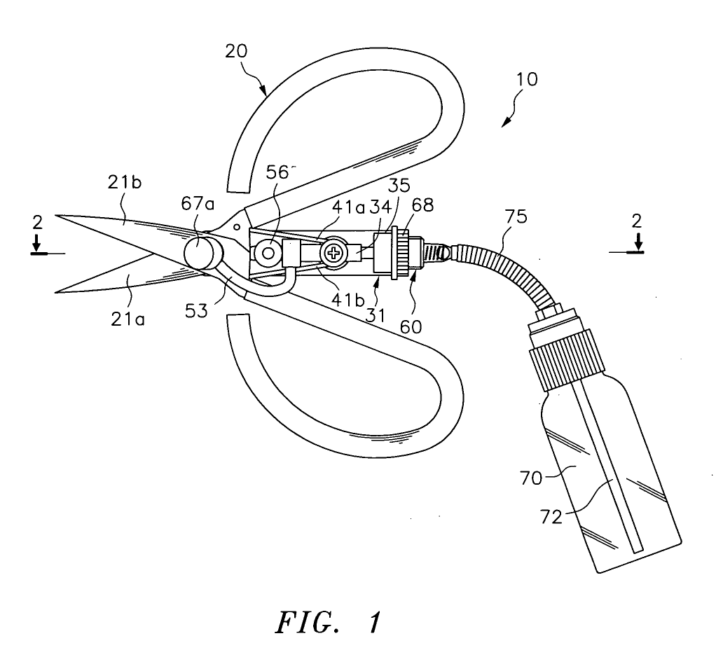

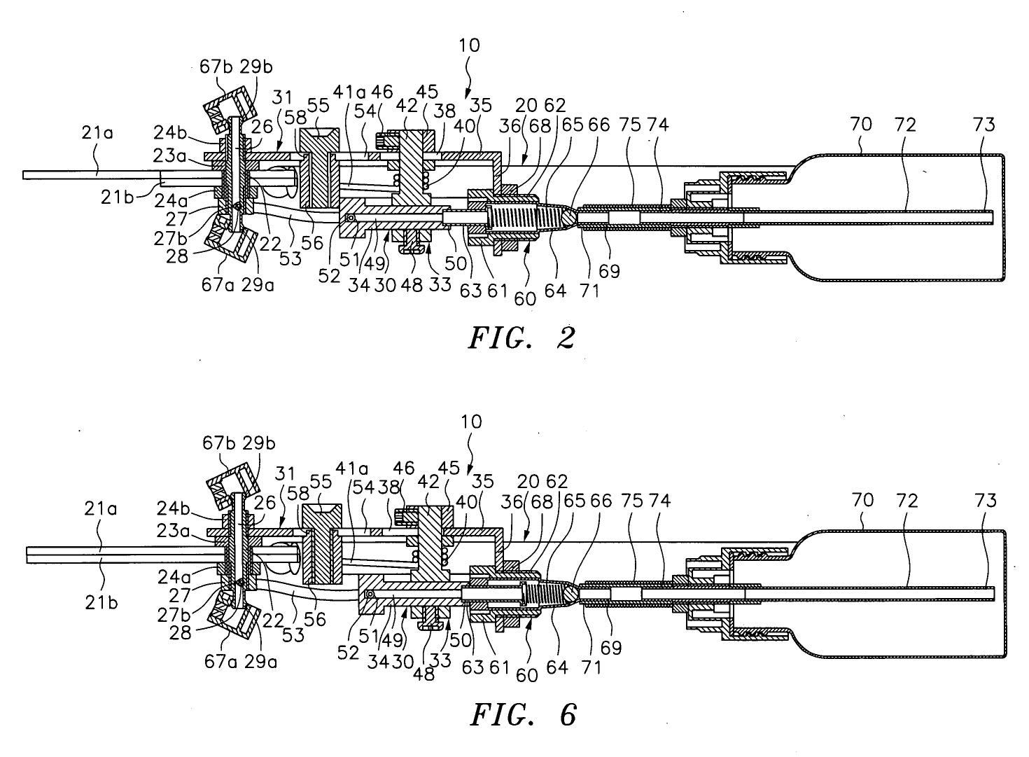

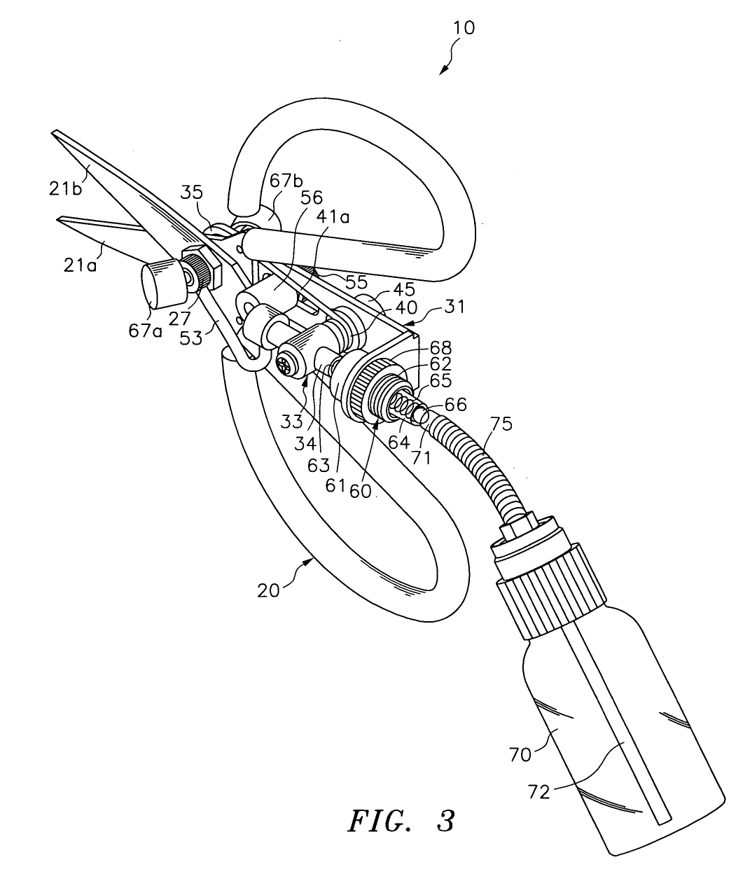

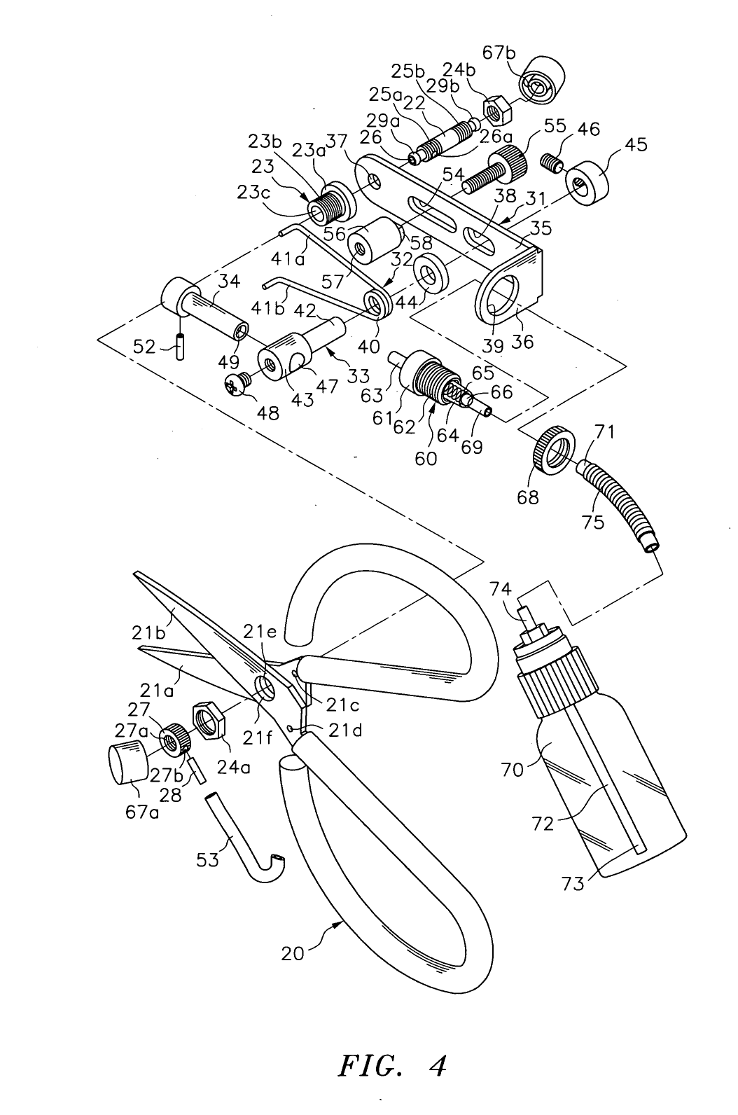

FIG. 1 is a plain view of a harvesting shears 10 in accordance with the present invention. FIG. 2 is a sectional view showing the internal structure of the harvesting shears 10. FIG. 3 is an oblique elevation of the harvesting shears 10. FIG. 4 is an exploded view of the harvesting shears 10. The harvesting shears 10 comprises a shears body 20. The shears body 20 is comprised of a first cutter blade 21a, a second cutter blade 21b, and a pivot device 23 that pivotally joins the first cutter blade 21a and the second cutter blade 21b for scissor action. The pivot device 23 comprises a bush 23a and a nut 24a. The bush 23a is non-isodiametric, having an externally threaded bush body 23b inserted through the respective pivot holes 21e and 21f of the two cutter blades 21a and 21b and fastened up with the nut 24a to pivotally secure the two cutter blades 21a and 21b together.

The aforesaid bush 23a has an axial center hole 23c for the passing of a tubular axle 22. The tubular axle 22 has a first outer thread 25a at one end, namely, the first end, and a second outer thread 25b at the other end, namely, the second end. After the tubular axle 22 is inserted through the axial center hole 23c of the bush 23a, one end of the tubular axle 22 is mounted with a cap 27, which has an inner thread 27a for fastening to the tubular axle 22, and the other end of the tubular axle 22 is fastened up with a nut 24b. Therefore, the tubular axle 22 is pivotally secured to the bush 23a. The tubular axle 22 has an axial passage hole 26 extending through its two opposite ends, and a radial through hole 26a extending through the periphery and in communication with the axial hole 26. A tubular connector 28 is fixedly fastened to a radial through hole 27b of the cap 27 and disposed in communication with the axial passage hole 26 of the tubular axle 22 through the radial through hole 26a. The tubular axle 22 has a first spherical connector 29a at one end and a second spherical connector 29b at the other end for the connection of a first nozzle tip 67a and a second nozzle tip 67b respectively (this will be described further).

Another important part of the present invention is the arrangement of an actuating mechanism 30 that works subject to the action of the shears body 20. The actuating mechanism 30 comprises a bracket 31, a spring 32, a link 33, and an actuating member 34. The bracket 31 comprises a horizontal frame part 35, and a vertical frame part 36 extending from the rear end of the horizontal frame part 35. The horizontal frame part 35 has a locating hole 37 near the front end for the passing of the tubular axle 22, and a longitudinal guide slot 38 on the middle for supporting reciprocating motion of the link 33. After insertion of the tubular axle 22 through the locating hole 37, the nut 24b is fastened to one end of the tubular axle 22 to secure the bracket 31 to the shears body 20. The vertical frame part 36 of the bracket 31 has a mounting hole 39 for the mounting of a nozzle assembly 60 (this will be described further).

The spring 32 according to this embodiment is a torsional spring having a spirally extending cylindrical spring body 40 facing the longitudinal guide slot 38 of the bracket 31 and coupled to the link 33, a first bearing arm 41a and a second bearing arm 41b respectively extending from the two opposite ends of the spring body 40 and respectively fastened to holes 21c and 21d at the cutter blades 21a and 21b. The spring 32 imparts a pressure to the shears body 20, holding the cutter blades 21a and 21b in an open status.

The link 33 comprises a shank 42 and a head 43. The shank 42 is inserted in proper order through the spring body 40 of the torsional spring 32, a gasket ring 44 and the guide slot 38 of the bracket 31, and then a socket 45 is mounted on the free end of the shank 42 of the link 33, and then an allen screw 46 is fastened to the socket 45 from one side to affix the socket 45 to the shank 42, thereby securing the link 33 to the spring 32 and the bracket 31 and allowing movement of the link 33 relative to the bracket 31. The head 43 of the link 33 has a radial through hole 47 for the passing of the actuating member 34. A screw 48 is mounted in the top side of the head 43 to affix the actuating member 34 to the head 43. Therefore, the link 33 and the actuating member 43 are firmly secured together in a crossed manner.

The actuating member 34 defines a flow passage 49. The flow passage 49 has an inlet 50 at the rear side, and an outlet 51 at the front side. A tubular connector 52 is affixed to the outlet 51 to connect a flow tube 53. The flow tube 53 has one end, namely, the rear end connected to the tubular connector 52, and the other end, namely, the front end connected to the tubular connector 28 at the tubular axle 22.

The nozzle assembly 60 comprises a stepped barrel 61 that has a relatively greater front part and relatively smaller rear part, an outer thread 62 extending around the periphery of the relatively smaller rear part of the stepped barrel 61 and inserted through the mounting hole 39 of the bracket 31 and then screwed up with a nut 68 to secure the nozzle assembly 60 to the bracket 31. Because the nozzle assembly 60 is fastened to the bracket 31 by means of the nut 68, the nozzle assembly 60 can be conveniently detached from the bracket 31 for cleaning or replacement when it is blocked or damaged after a long use. The nozzle assembly 60 has a reducer 64 fixedly mounted in the stepped barrel 61 to receive a compression spring 65 and a steel ball 66, and to support linear motion of a coupling tube 63. The coupling tube 63 has its front end inserted into the inlet 50 of the flow passage 49 of the actuating member 34 and fixedly secured thereto for synchronous movement with the actuating member 34, and its rear end slidably inserted into the reducer 64 to compress the spring 65.

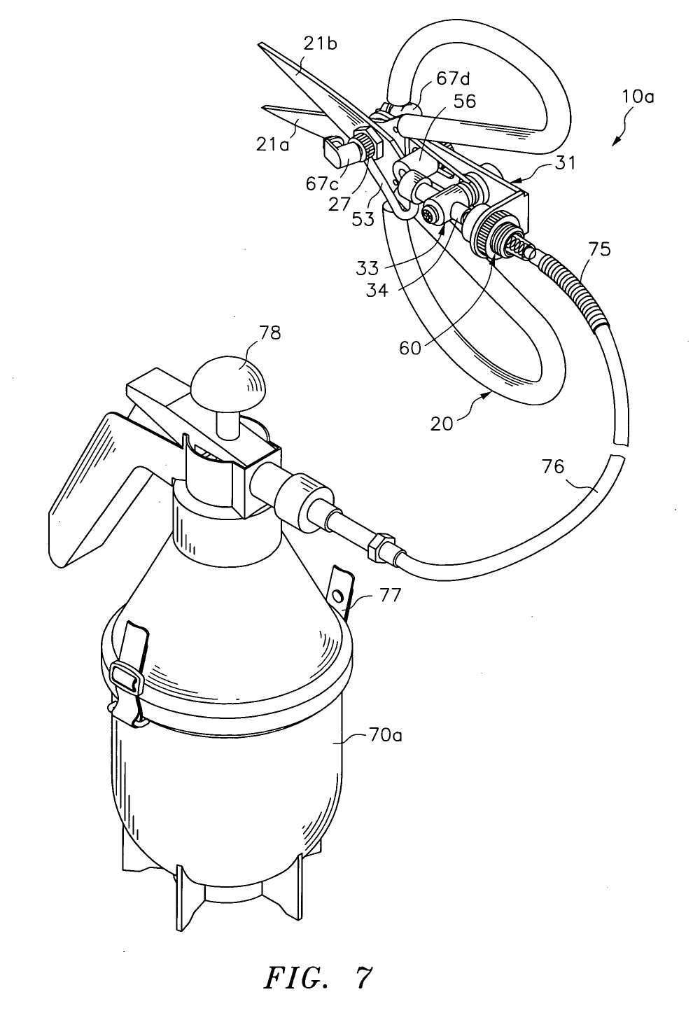

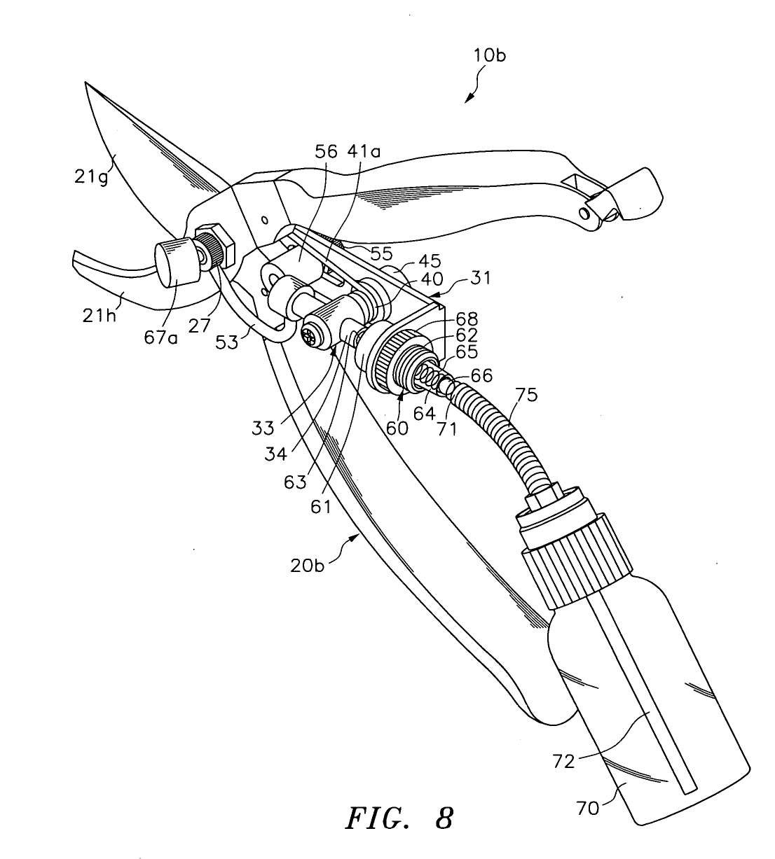

The nozzle assembly 60 further comprises the aforesaid two nozzle tips 67a and 67b that are detachably mounted on the spherical connectors 29a and 29b of the tubular axle 22. After installation, the nozzle tips 67a and 67b can freely be turned about the respective spherical connectors 29a and 29b to the desired angle for spraying a chemical fluid to the cutting edges of the cutter blades 21a and 21b or the cut cross section of the stalk (or twig). The nozzle tips 67a and 67b are adapted to eject mist of very fine drops of chemical fluid. Alternatively, the nozzle tips 67c and 67d shown in FIG. 7 may be used as a substitute to eject a stream of chemical fluid. When desired, one each of the aforesaid two different types of nozzle tips may be used and respectively fastened to the spherical connectors 29a and 29b of the tubular axle 22. The nozzle assembly 60 is obtained from known techniques commonly seen in daily products, such as body lotion sprayers, detergent sprayers, bathroom, and kitchen spray cleaners. Therefore, no further detailed description in this regard is necessary.

The aforesaid reducer 64 reduces in radial direction toward its rear end and terminating in a connecting portion 69 for the connection of a flexible stub tube 71. The other end of the flexible stub tube 71 is connected to a dip tube 72. A tensile spring 75 is sleeved onto the flexible stub tube 71 to hold down the connecting portions at the two ends of the flexible stub tube 71, prohibiting disconnection of the flexible stub tube 71 from the reducer 64 or the dip tube 72. This design allows separation of the flexible stub tube 71 from the reducer 64 or the dip tube 72 by a person. The dip tube 72 is inserted into a small chemical fluid container 70. One end, namely, the input end 73 of the dip tube 72 extends to the inside of the small chemical fluid container 70 approaching the bottom of the small chemical fluid container 70. The other end, namely, the output end 74 of the dip tube 72 extends to the outside of the small chemical fluid container 70 and connected to the flexible stub tube 71. The small chemical fluid container 70 contains a chemical fluid. Preferably, the small chemical fluid container 70 is transparent so that the user can check the amount of chemical fluid visually, and give a new supply when necessary.

Because the small chemical fluid container 70 is connected to the nozzle assembly 60 through the flexible stub tube 71 and contains a chemical fluid, it hangs down. Therefore, the fluid level of the chemical fluid in the small chemical fluid container 70 is constantly kept above the elevation of the dip tube 72 no matter whether the harvesting shears 10 is held in an upward, downward, horizontal, or any of a variety of other operation position, allowing the nozzle assembly 60 to dispense the chemical fluid from the small chemical fluid container 70.

According to the present preferred embodiment, the bracket 31 further has an elongated slot 54 in front of the link 33 for the passing of a lock screw 55 that is threaded into the inner thread 57 of a stop member 56 to secure the stop member 56 to the bracket 31 in front of the actuating member 34. The stop member 56 has a rectangular protrusion 58 inserted into the elongated slot 54 to prohibit rotation of the stop member 56 relative to the bracket 31. When loosened the lock screw 55, the stop member 56 can be moved along the elongated slot 54 to adjust the distance between the stop member 56 and the actuating member 34 and to further control the maximum opening angle of the shears body 20.

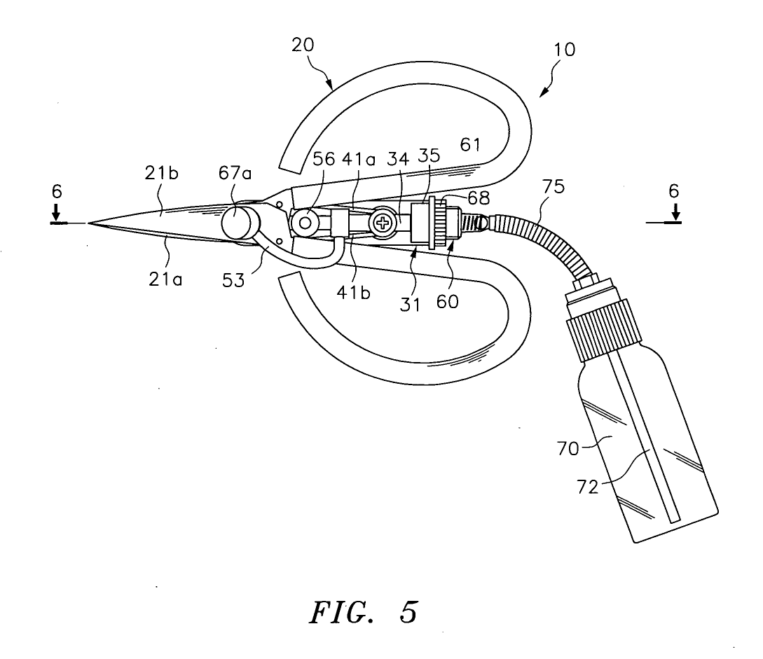

Referring to FIGS. 5 and 6, when the user operates the shears body 20 to cut off the stalk (or twig), the bearing arms 41a and 41b of the torsional spring 32 receive a pressure from the cutter blades 21a and 21b, causing the spring body 40 to bear a torque, and at the same time the link 33 and the actuating member 34 are forced to move backwards (right side in FIGS. 5 and 6) and to give a pressure to the coupling tube 63 of the nozzle assembly 60. When the coupling tube 63 is moved by the actuating member 34, a flow of air is forced into the inside of the small chemical fluid container 70 to force chemical fluid out of the small chemical fluid container 70 through the dip tube 72, the flexible stub tube 71, the reducer 64 and the coupling tube 63 toward the nozzle tips 67a and 67b through the flow passage 49 of the actuating member 34 and the flow tube 53 via the tubular axle 22, and therefore, the chemical fluid is sprayed onto the cutting edges of the cutter blades 21a and 21b, or the cut cross section of the stalk or twig (subject to the installation angle of the nozzle tips 67a and 67b, and therefore cutting and sterilizations are done at one time, increasing working efficiency and preventing serious consequences due to non-sterilization of the harvesting scissors 10.

Because the two nozzle tips 67a and 67b are provided at two sides of the harvesting scissors 10, there is always one nozzle tip 67a or 67b facing the cut cross section of the stalk or twig and forced to spray the chemical fluid onto the cut cross section of the stalk or twig during the cutting operation of the harvesting scissors 10. The harvesting scissors can be made having only one nozzle tip at one side. In this case, the harvesting shears to be kept in such a position where the nozzle tip is aimed at the stalk or twig. For ease of operation, the harvesting shears is better provided with two nozzle tips at two opposite sides.

When released the pressure from the harvesting shears 10, the spring force of the torsional spring 35 forces the two cutter blades 21a and 21b of the shears body 20 apart, and the link 33 as well as the actuating member 34 and the coupling tube 63 are returned (the spring 65 of the nozzle assembly 60 also imparts a pressure to return the link 33 with the actuating member 34 and the coupling tube 63) for a next cutting and sterilizing operation.

The present invention can be made in any of a variety of alternate forms. According to the embodiment shown in FIG. 7, a big chemical fluid container 70a and a nozzle assembly 60 are connected to a harvesting shears 10a through a long flexible tube 76. The big chemical fluid container 70a has a shoulder strap 77 for carrying on the body of a person. The long flexible tube 76 has one end fastened to the nozzle assembly 60 tightly by a tensile spring 75, and the other end connected to the big chemical fluid container 70a by means of a connector. According to the embodiment shown in FIGS. 1˜6, the small chemical container 70 hangs down naturally, and the user's hand directly bears the gravity of the small chemical container 70. Therefore, this embodiment does not allow for a big size of chemical container. According to the embodiment shown in FIG. 7, the big chemical fluid container 70a is kept spaced from the nozzle assembly 60 at a distance and can be carried on the user's body. Therefore, the big chemical fluid container 70a is allowed to hold much the chemical fluid, reducing the chemical fluid supply frequency. Because there is a big distance between the nozzle assembly 60 and the big chemical fluid container 70a, the big chemical fluid container 70a can be accumulator type so that the contained chemical fluid can easily be forced out of the big chemical fluid container 70a through the long flexible tube 76 toward the nozzle tips 67c and 67d for application. According to the embodiment shown in FIG. 7, the big chemical fluid container 70a is a chemical fluid dispenser, and the reference number 78 indicates a pressure device (saddle head and piston assembly) of the chemical fluid dispenser.

FIG. 8 is a perspective view of a thinning shears 10b according to the present invention. This embodiment is substantially similar to the aforesaid first embodiment with the exception that the shape of the cutter blades 21g and 21h of the shears body 20b is different from the shape of the cutter blades 21a and 21b of the harvesting shears 10. Same reference numbers are used in the embodiment shown in FIG. 8 to indicate the parts of the shinning shears 10b that are identical to like parts of the embodiment shown in FIGS. 1˜6.

Although particular embodiments of the invention have been described in detail for purposes of illustration, various modifications and enhancements may be made without departing from the spirit and scope of the invention. Accordingly, the invention is not to be limited except as by the appended claims

What the invention claimed is:

1. A gardening shears comprising:
a shears body, said shears body comprising two cutter blades, and a pivot device pivotally securing said cutter blades together;
a tubular axle inserted through and fixedly secured to said pivot device, said tubular axle comprising an axial passage hole and a first connector at a first end thereof;
an actuating mechanism, said actuating mechanism comprising a bracket fixedly fastened to said shears body, said bracket comprising a longitudinal guide hole, a spring member, said spring member having a spring body and two bearing arms respectively extending from said opposite ends of said spring body and respectively fastened to said cutter blades of said shears body, a link inserted through said spring body of said spring member and said longitudinal guide hole of said bracket and movable along said longitudinal guide hole, and an actuating member fixedly mounted on said link, said actuating member having a flow passage, an inlet at one end of said fluid passage, and an outlet at an opposite end of said fluid passage;
a flow tube connected between the axial passage hole of said tubular axle and the outlet of said actuating member;
a nozzle assembly, said nozzle assembly comprising a barrel mounted in said bracket, a reducer fixedly mounted in said barrel, a compression spring mounted in said reducer, a steel ball mounted in said reducer and stopped at one end of said compression spring, a coupling tube, said coupling tube having a front end inserted into said inlet of said flow passage of said actuating member and fixedly secured thereto for synchronous movement with said actuating member and a rear end slidably inserted into said reducer for compressing said compression spring, and a first nozzle tip coupled to said first connector of said tubular axle;
a container, said container comprising a dip tube, said dip tube having an input end suspending in said container and an output end extending out of said container; and
a flexible tube, said flexible tube having a first end connected to said reducer of said nozzle assembly and a second end connected to the output end of said dip tube.

2. The gardening shears as claimed in claim 1, wherein said pivot device comprises a bush, said bush having an axial center hole; said tubular axle is inserted through the axial center hole of said tubular axle, having one end mounted with a cap and an opposite end fastened up with a nut.

3. The gardening shears as claimed in claim 2, wherein further comprising a tubular connector fixedly fastened to said cap to connect said flow tube, said tubular connector being disposed in communication with the axial passage hole of said tubular axle through a through hole on said tubular connector.

4. The gardening shears as claimed in claim 1, wherein said bracket comprises an elongated slot, a stop member movable along said elongated slot, and a lock screw adapted to lock said stop member to said bracket.

5. The gardening shears as claimed in claim 4, wherein said stop member has a protrusion engaged into said elongated slot.

6. The gardening shears as claimed in claim 1, wherein said tubular axle further comprises a second connector at a second end thereof; said nozzle assembly further comprises a second nozzle tip coupled to said second connector of said tubular axle.

7. The gardening shears as claimed in claim 6, wherein the first connector and second connector of said tubular axle are spherical connectors.

8. The gardening shears as claimed in claim 6, wherein said first nozzle tip and said second nozzle tip are adapted to spray a mist of fine drops of a fluid.

9. The gardening shears as claimed in claim 6, wherein said first nozzle tip and said second nozzle tip are adapted to eject a stream of a fluid.

10. The gardening shears as claimed in claim 6, wherein said first nozzle tip is adapted to spray a mist of fine drops of a fluid, and said second nozzle tip is adapted to eject a stream of a fluid.

11. The gardening shears as claimed in claim 1, wherein said barrel of said nozzle assembly has an outer thread for the mounting of a locknut to lock said barrel to said bracket.

12. The gardening shears as claimed in claim 1, said flexible tube connects said container to said reducer of said nozzle assembly in such a manner that said container suspends from said scissors body in air when the gardening shears is operating by a person.

13. The gardening shears as claimed in claim 12, wherein further comprising a tensile spring sleeved onto said flexible tube to hold down the connection between said flexible tube and said nozzle assembly and the connection between said flexible tube and said dip tube.

14. The gardening shears as claimed in claim 1, wherein said container is equipped with a shoulder strap for carrying on the body of a person.

15. The gardening shears as claimed in claim 14, wherein said big container is equipped with a pressure device.

16. The gardening shears as claimed in claim 14, wherein further comprising a tensile spring sleeved onto said flexible tube to hold down the connection between said flexible tube and said nozzle assembly.
